(19) United States
(12) Patent Application Publication
(10) Pub. No.: US 2011/0217022 A1
(43) Pub. Date: Sep. 8, 2011

(54) SYSTEM AND METHOD FOR ENRICHING VIDEO DATA

(76) Inventors: Ofer Miller, Singapore (SG); Amir Segev, Raanana (IL); Nadav Kehati, Azriel (IL); Sagi Gordon, Tel Aviv (IL)

(21) Appl. No.: 13/125,008

(22) PCT Filed: Nov. 5, 2009
(86) PCT No.: PCT/IL09/01035

§ 371 Date: Apr. 19, 2011

Related U.S. Application Data
(60) Provisional application No. 61/193,221, filed on Nov. 6, 2008.

(51) Int. Cl. G11B 27/00; H04N 5/93

(52) U.S. Cl. 386/278; 386/E05.028

(57) ABSTRACT

A method for enhancing video data comprises a) extracting said video data into a plurality of segments; b) analyzing said extracted video data with regard to one or more features within or between said segments; c) finding at least one location for placing at least one message in one of said segments; and d) integrating a message at said at least one location according to information obtained from user consumption and/or interaction with the video.

### FIELD OF THE INVENTION

The present invention relates to a system and to a method for enriching video data, and in particular, to such a system and method in which the location of added content in video data is determined.

### BACKGROUND OF THE INVENTION

Video clips, also referred to herein as “video”, may be viewed through various types of services. Certain of these services operate through the Internet, enabling viewers to remote select and then play video clips for viewing on their computers. A non-limiting example of a web site offering such an experience is YouTube®, although any type of web site offering video data may optionally be considered, including with regard to professional video, “viral” advertisements, movie trailers, serial video shows (television series and the like) and any other type of video content.

However, once a video has been created and uploaded to a system there is no easy way to add content to it in a manner individually suitable for an audience or group of users. This problem is compounded by the fact that it is often desired to couple to a video stream information that differs from one location to another, or from one system to another. Thus, for instance, if a tutorial is generated by the manufacturer of a tool, a specific user of the tool has no simple way to exploit the layout of the video to add to the tutorial specific additional information that may be relevant to a particular segment of users of the tool, be they its clients or its employees. So far, the art has failed to provide a dynamic solution to this problem, which may take into account feedback received from the users.

### SUMMARY OF THE INVENTION

The method for enhancing video data according to the invention comprises:
a. extracting said video data into a plurality of segments;
b. analyzing said extracted video data with regard to one or more features within or between said segments;
c. finding at least one location for placing at least one message in one of said segments; and
d. integrating a message at said at least one location according to information obtained from user consumption and/or interaction with the video.

The message can be of any suitable type and may comprise, for instance, a text message, an advertisement, a picture, a video, animation, or an object representation.

The location to be used according to the invention can be determined in any suitable manner and, e.g., is determined based on temporal segmentation, or based on spatial segmentation, or based on motion segmentation. However, the invention is not limited to any specific method of video analysis and any suitable method can be used to carry out the invention.

In many cases it is advantageous to determine the location such that it is believed to maximize the probability of capturing the attention of a viewer and thereby increase its involvement in the information. In other cases the location is determined according to a required intrusiveness level. According to one embodiment of the invention the location is empirically determined according to at least one viewer behavior parameter. These will be further elaborated hereinafter.

The viewer behavior parameter can be determined, for instance, according to at least one prior display of the message within the video data, or according to historical information regarding one or more displays of different items of video data.

In one embodiment of the invention the viewer behavior is analyzed according to mouse tracking, click through, viewer interactions, counting the number of people viewing the clip or by tracking viewer behavior, or by a combination thereof.

The message type and the message location can be adapted to the user profile and/or one or more preferences, for instance, using cookies that allow to determine specific user's preferences.

The video data is used in streaming video, file video, on line video, download, XVOD (Video on Demand) applications, mobile content, television applications, post/pre production applications, or cinema content. The video data is obtained, e.g., from compressed video such as WM9, VC1, MPEG4, MPEG 4 AVC, MPEG2, H263, H.264, AVI or any form of compressed consecutive frames.

The extraction can be performed in different ways, e.g., by analyzing the movement of objects within the segment, or by segmentation of the video in the temporal or spatial domains within the segment or in any other suitable way.

Feedback regarding the message can be generated after the placing of the message and can be supplied by viewers or by publishers. Alternatively, it can be generated “on the fly” during the placement of the message, or can be predicted using statistical data.

The invention is also directed to a method for selecting a message for display on/in video data from a plurality of available messages, comprising:
a. analyzing the video data to provide at least one location for displaying said message;
b. determining one or more location parameters; and
c. selecting said message for placement in said location according to said one or more location parameters.

The invention is further directed to a system for enriching video data, which comprises:
a. a video provisioning computer for supplying videos;
b. an extracting module for extracting said video data into a plurality of frames;
c. an analyzer module for analyzing the extracted video data with regard to one or more features within or between said frames; and
d. a segmentation module for segmenting the video data into one or more segments;

wherein the invention comprises further providing a real estate module for finding at least one location for placing at least one message in said segment.

The above and other objects of the invention will be further illustrated as the description proceeds.

### BRIEF DESCRIPTION OF THE DRAWINGS

The invention will be described hereinafter, by way of example only, with reference to the accompanying drawings. With specific reference now to the drawings in detail, it is stressed that the particulars shown are by way of example and for purposes of illustrative discussion of the preferred embodiments of the present invention only. In this regard, no attempt is made to show illustrative examples of embodiments of the invention in more detail than is necessary for a fundamental understanding of the invention, the description taken with the drawings making apparent to those skilled in the art how the several forms of the invention may be embodied in practice. Furthermore, the examples used herein where chosen for their simplicity and ease of explanation and for the sake of brevity, and the skilled person will easily appreciate that the invention applies to different situations, methods, videos and types of messages.

In the drawings:

FIG. 1 is a schematic block diagram of an exemplary system according to the present invention;

FIG. 2 shows a flowchart of an exemplary method according to the present invention for message combination with video;

FIG. 3 shows a flowchart of an exemplary method according to the present invention for obtaining feedback regarding viewer interactions with a message in the video data;

FIG. 4 shows a flowchart of an exemplary method of a preliminary step according to the present invention, for detecting the locations for inserting the messages;

FIG. 5 shows a flowchart of an exemplary method according to the present invention for deciding which message to insert in each location; and

FIG. 6 shows a flowchart of an exemplary method according to the present invention for inserting a message within a particular location.

### DETAILED DESCRIPTION OF EMBODIMENTS OF THE INVENTION

As explained above there is an unmet need for, and it would be highly useful to have, a system and a method for placement of a message in video data, in which the location for the placement is selected to be conspicuous without undue irritation or distraction to the viewer, to maximize attentiveness. There is an unmet need for intelligent placement of such messages, based on requirements from the content provider, and by maximizing the probability of capturing the eye of the viewer by controlling the level of intrusiveness. Requirements from content providers can be of many different types and may affect the size, location and number of messages added to the video data.

According to the present invention the location (and optionally characteristics such as size and duration) for the placement are set, using foreground and background analysis and grading the appropriate location in which one or more messages are to be placed. Such analysis can be done, for example by using video content analysis and segmentation methods known in the art, e.g., as described in the article Automatic Adaptive Segmentation of Moving Objects Based on Spatio-Temporal Information written by Ofer Miller, Amir Averbuch, and Yosi Keller; School of Computer Sciences, Tel-Aviv University and in the article Color Image Segmentation Based on Adaptive Local Thresholds; Written by Ety Navon, Ofer miller, Amir Averbuch; School of Computer Science Tel-Aviv University.

Results can be optimized and hence empirically determined according to at least one viewer behavior parameter, and optionally also one or more of market requirements and content nature. Such interaction can be determined, for example, by mouse tracking, by clicks or by counting the number of people viewing the clip or by tracking viewer behavior. Tracking viewer behavior can be done, for example, by analyzing statistics. The viewer behavior parameter, which is the parameter describing the viewer's behavior, is preferably determined according to at least one prior display of the message within a particular item of video data, such as a particular video clip, for that item of video data. However, the viewer behavior parameter may also optionally be determined according to historical information regarding one or more displays of other, different, items of video data, and a combination of all the parameters. The present invention can also be exploited to place advertising material in video streams. By better defining the location of advertisement messages the invention provides the ability to position the advertisement in a place that is more relevant, less intrusive and better capture the eye of the video viewer. The viewer behavior parameter, as well as market price, content nature and viewer nature may affect the volume of the messages that are inserted into the spots, the volume of the spots and the volume of the video data. The adaptation of the volume is preferably done by assigning a weight for each of the above parameters (as further elaborated hereinafter), calculating a number which is a combination of at least these parameters, and tracking the result over time.

According to one embodiment of the present invention, parameters such as the matching between the advertisement type, context and the video content, the price of the advertisement, the type of advertisement (static, animated and so forth), size, and the like are preferably taken into consideration while placing one or more advertisement.

According to an embodiment of the present invention the system can be used to analyze where the viewer's attention is directed. The present invention can analyze the attractiveness of the real estate (the location where the message is inserted) according to one or more characteristics such as the physical location of the message, location in spatial and/or temporal domains, size, duration, intrusiveness and other such characteristics, or of the movie trailer or of the message itself.

According to still other embodiments of the present invention, the user of the system of the invention is able to test the attention of the viewer by monitoring click-through interactions, whereby an additional message is placed in the video clip and the viewer then interacts with this message. The message can optionally be a link to a web page containing more information pertinent to the message (for instance, additional tutorials or continuously updated information). The location of the additional message is optionally and preferably tested according to the method described herein for selecting a suitable location for the message.

The hardware used to perform the method of the invention includes, inter alia, image processing apparatus, data retrieval and storage equipment (such as one or more servers and related data storage areas to store and manage one or more databases), communication equipment (e.g., to acquire user data), as well as other apparatus known in the art. The system can be implemented by cooperatively operating separate (and even geographically apart) elements, or all or a number of the active equipment can be integrated into a single unit. Various system configurations can be devised by the skilled person, according to the processes described herein, which are not discussed in detail, for the sake of brevity.

The parameters that affect the decision to change the type, location and frequency of information displayed can be grouped into three main groups:

Content consumption, encapsulating all relevant information that is relevant to consumption, such as video popularity, when it was consumed, where, by which population segments, how many times, virality, etc.

Attentiveness, encapsulating all relevant information that is relevant to user attention (relative to the info/ad and or the content itself), such as when the average user left the movie, switched to large screen, mouse over, clicks, conversion (in case of an ad), closing info x button, etc.

Users, encapsulating all relevant information that is relevant to a specific user, such as maximum volume of info per video, preferred size, preferred appearance, preferred frequencies, etc.

Each parameter has its own weight and, additionally, weights are assigned to the three segments. The weight of each parameter can be fixed (e.g., based on statistical data), or can be dynamic and change according to a learning process. The weights help solving any potential collision between contrasting needs derived from different parameters. As will be understood by the skilled person, different parameters and weights apply to different types of information, audiences and video, and the invention is not intended to be limited to any specific parameter or weight, or combination thereof.

In a specific example the weight assigned to the “content attentiveness” segment is 74%, and that of the “consumption” segment is 26%. In this specific example the “users” segment is activated only after they visited a specific site more than 4 times a week.

The weights of the segments change with time in order to reach optimal maxima, according the rules defined by the site (for example the portfolio of info sizes).

In a particular example weights are changed every few hours, taking also into account issues such as weekends, holidays, and “dead hours”.

Unless otherwise defined, all technical and scientific terms used herein have the same meaning as commonly understood by one of ordinary skill in the art to which this invention belongs. The materials, methods, and examples provided herein are illustrative only and not intended to be limiting. The message is not limited to any particular type and can be visual (i.e., an image or a video), static or dynamic, audible or written.

Implementation of the method and system of the present invention involves performing or completing certain selected tasks or steps manually, automatically, or a combination thereof. Moreover, according to actual instrumentation and equipment of embodiments of the present invention, several selected steps can be implemented by hardware or by software on any operating system of any firmware or a combination thereof. For example, as hardware, selected steps of the invention can be implemented as a chip or a circuit. As software, selected steps of the invention can be implemented as a plurality of software instructions which are executed by a computer using any suitable operating system. In any case, selected steps of the method and system of the invention can be performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, STB (Set-Top Box) server or a PVR (Personal Video Recorder) and video server. Any two or more of such devices in communication with each other, and/or any computer in communication with any other computer may optionally comprise a “computer network”.

Although the present invention is described with regard to a “message”, it should be noted that optionally any message such as an advertisement, informational messages such as, for example a message including information about the release date of a movie if the video clip is a movie trailer, background information about the content, metadata, information about objects within the scene, and subtitles, may be described as a message. The message may for example be an overlay or embedded within the movie. In addition any message featuring a picture, text, video, animation, audio, a plurality of frames or images, or an object, including one interacting with another object in the content, whether static or animated, may also be described as a message.

Although the present invention is described with regard to a “video”, it should be noted that optionally any form of compressed video such as WM9, VC1, MPEG4, MPEG 4 AVC, MPEG2, H263, H.264, AVI or any form of compressed consecutive frames, may be described as a video.

Preferably the viewer behavior parameter includes a determination of viewer interest in the message according to some type of interaction between the message and the viewer. For example, for video data displayed through a computer network such as the Internet, the viewer may “click on” or otherwise select the message with a mouse or other pointing device, or a touch screen, or other indicate an interaction with the message through some type of interaction with the keyboard, joystick or other user interface device.

The principles and operation of the present invention may be better understood with reference to the drawings and the accompanying description.

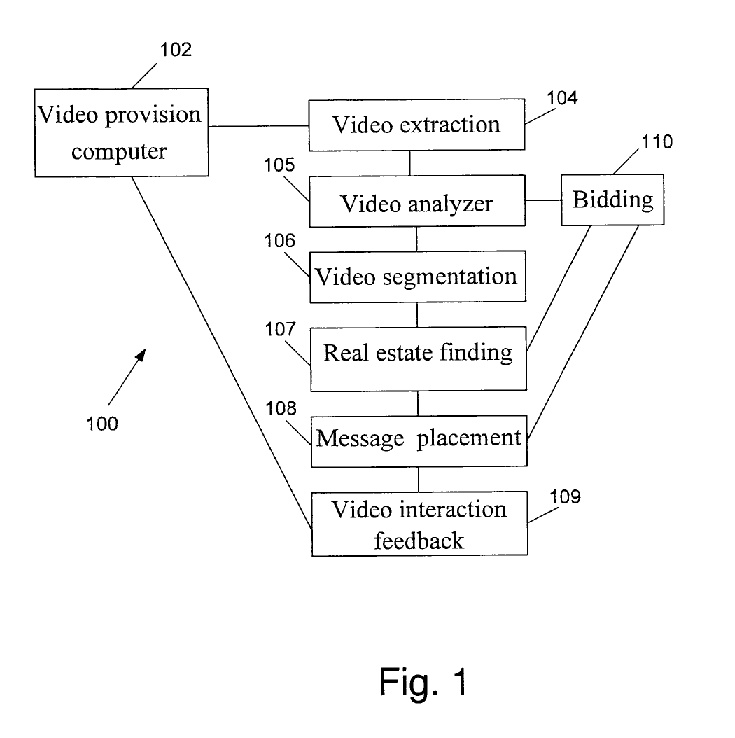

Referring now to the drawings, FIG. 1 is a schematic block diagram of an exemplary system according to the present invention for placement of a message in video data, in which the location for the placement is set by using video content analysis and segmentation and empirically determined and optimized, as described above, according to at least one viewer behavior parameter. Although the example given below refers to the placement of an advertisement, for the sake of simplicity, it is understood that this example is given for the purpose of illustration only and is not meant to be limiting in any way.

FIG. 1 shows a system 100 according to the present invention. As shown, a system 100 features a video provision computer 102 for providing video data to a video extraction module 104, which then preferably extracts the necessary components from the video data. For example, video extraction module 104 may optionally decompose the video data into a plurality of frames. The video data can be used in streaming and on-line video download, XVOD (Video on Demand) applications, mobile content, television applications, post/pre production applications, cinema content and the like.

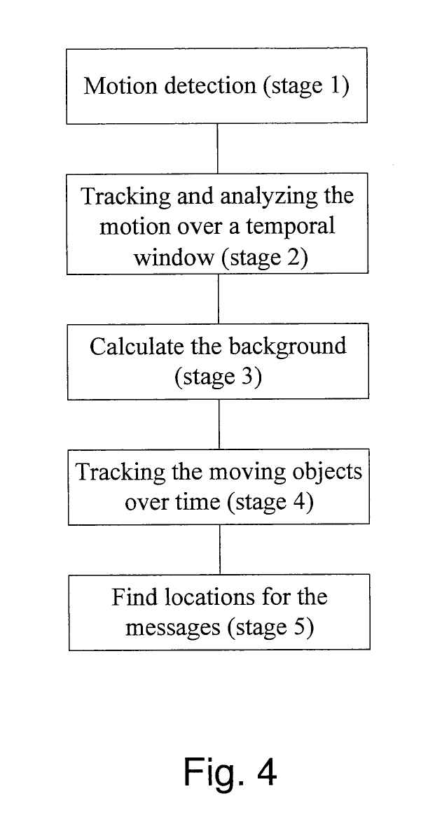

Video analyzer module 105 analyses the extracted video data with regard to one or more features within or between frames, for example including but not limited to ROI (region of interest of a specific user), camera movements and tracing, global motion, objects analysis, face detection, objects recognition, homogeneity, spatial activity, video quality, color segmentation, temporal segmentation, spatial segmentation, edge segmentation, and psycho analytic models to model eye movements and eye tracking, the movement of objects within a frame or the position of one or more objects of interest to the view in a frame or between frames, as described in greater detail below with regard to FIG. 4. Next, video segmentation module 106 preferably determines the existence of one or more segments, which are a series of frames or other portion of the video data during which a message may be shown. Then, real estate finding module 107 finds the messages' potential location, preferably according to criteria such as content, intrusive level, timing and duration of movement of an object, object type, background color, ROI (region of interest), color of the object, price of the advertisement (in the cases when a message is an advertisement) and the like. In addition, video real estate module 107 preferably provides the analyzed information to a bidding module 110, for determining the pricing of placement of an advertisement in the video data.

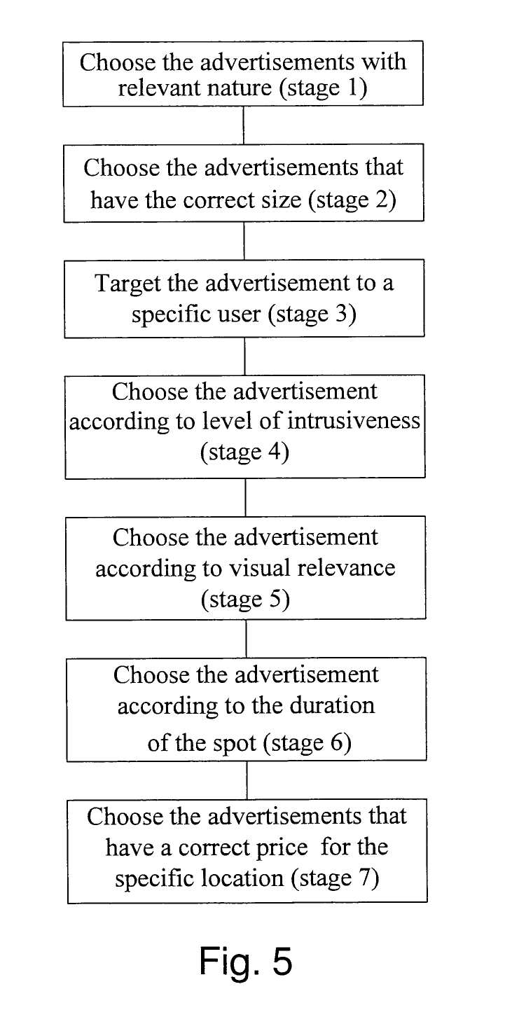

In an embodiment of the invention bidding module 110 operates according to an auction method, in which the highest bidder is able to place an advertisement in the video data, although of course other pricing models are also optionally provided, in addition to or in place of the auction model. Bidding module 110 determines which advertisement(s) are to be placed in an item of video data; this information is then provided to message placement module 108 for preparation of the item of video data as described above (and as described in greater detail below with reference to FIG. 5).

Message placement module 108 places one or more messages according to one or more real estate definition parameters or requirements. Real estate module 107 preferably determines the preferred targeting of any advertisements or other messages, for example with regard to target audience, desired demographics and so forth. Such an analysis preferably also includes information obtained from previous analyses of video data and also, optionally, from previous viewer interactions with a message or other advertisement. After placing the messages, video interaction feedback module 109 generates feedback. Such feedback can be feedback and interaction from users (such as number of clicks on an advertisement, starting and stopping the play and the like), feedback from the publisher and the like. The feedback can be used for optimizing the location of the messages in future viewings. Video interaction feedback module 109 preferably at least measures the apparent interest of one or more viewers in the item of video data, for example with regard to download requests. Video interaction feedback module 109 may also measure any interactions between the viewer and a message in the video data, e.g., according to “click through” actions or other interactions with the message. Thus, for instance, if the message relates to a tutorial distributed within an organization, there is an interest in learning what percentage of employees have clicked on a link to obtain additional information regarding the subject. Again, such interactions may optionally be measured directly through data passed to a central unit from the user computers, or alternatively may optionally be measured indirectly through interactions of the user computers with a video server (not shown).

For example, and without limitation, if the viewer is viewing a video clip through a video player, whether as a stand alone player or a player provided through a web browser, whether offline or online, one or more “hooks” are able to extract information regarding the behavior of the viewer. Such hooks may detect actions of interest, for example with regard to when the viewer stops, starts, pauses, passes the mouse over a video, etc. These actions can then be provided, directly or indirectly, to a video interaction feedback module 109.

Information regarding such feedback and interactions is then passed to bidding module 110, according to this particular example, in order to affect pricing and other considerations for the advertisements. Of course, if the message has no commercial content, in many cases bidding module 110 will not be needed and can be dispensed with, or may be replaced by a module that uses other consideration, such as instructions received by a publisher or other entity, to influence the parameters that govern the messages to be placed in the video data. Optionally, bidding module 110 (or a module that replaces it, as discussed hereinbefore) may instruct video preparation module 108 to cease using one or more locations, and/or to increase the usage of one or more locations, according to the efficacy of the viewer interactions with the advertisement.

In addition, information regarding such feedback and interactions is also provided to video provision computer 102, for example to inform the owner of the video data regarding viewer interest in the video clip or other item of video data. Additionally, if the message has no commercial content and bidding module 110 is not provided, provision computer 102 may utilize the information received from video interaction feedback module 109 to determine message locations taking into account users' feedback.

Optionally, each of video extraction module 104, video analysis module 105 video segmentation module 106, real estate finding module 107, message replacement module 108 and video interaction feedback module 109 may be implemented on separate computers or groups of computers; alternatively a plurality of such modules may be located on a single computer or groups of computers. Furthermore, the designation of separate modules is intended for a logic diagram only; the actual operating modules may optionally be combined or separated in other ways. Furthermore the initial video data may not be provided through video provision computer 102, but instead it can be optionally provided “off line”. The bidding process of bidding module 110 may also optionally be performed on line and/or off line. Although the process can be fully automated in many instances, a user may optionally perform one or more manual adjustments to the results of the automatic process.

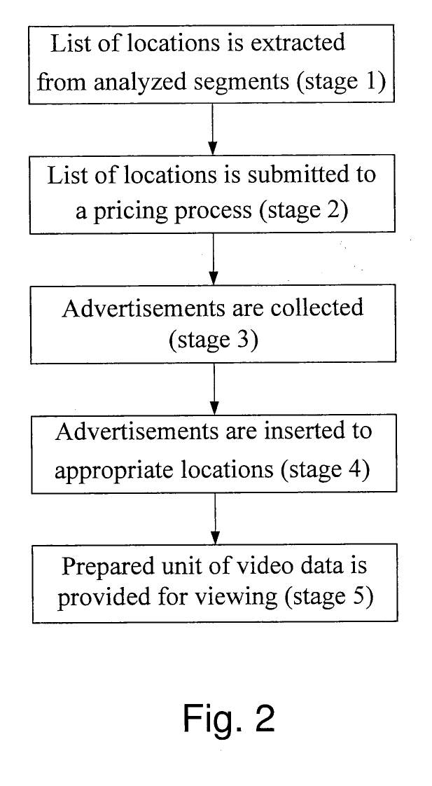

FIG. 2 shows a flowchart of an exemplary method for video preparation, according to some embodiments of the present invention. This figure provides an overview of the video preparation method which is employed according to some embodiments of the present invention when the message is an advertisement; a more detailed technical description of an exemplary embodiment of such a preparation method is provided below.

In stage 1, the analyzed video data for each segment is further analyzed to provide a list of locations, the one or more types of advertisements that are suitable for each location, the quality of each location and the duration of each location.

In stage 2, this list is submitted to a pricing process, which is, e.g., an auction process. The pricing process determines the price for each location, as well as optionally determining a maximum number and/or type of locations that may be filled for each viewing of the video data. If an auction process is used, preferably the highest bidder (or other designated “winner” of the bidding process) for each location is selected for providing the advertisement for that location.

In stage 3, the advertisement(s) from the successful bidder(s) are collected, along with the corresponding location(s) for which the bid was made.

In stage 4, each advertisement is inserted into each location for which a successful bid was made. The technical process for such an insertion is described in greater detail below.

In stage 5, the prepared unit of video data, e.g., a video clip, is provided for viewing.

Although the process can be fully automated in many cases, a user may optionally perform one or more manual adjustments to the results of the automatic process.

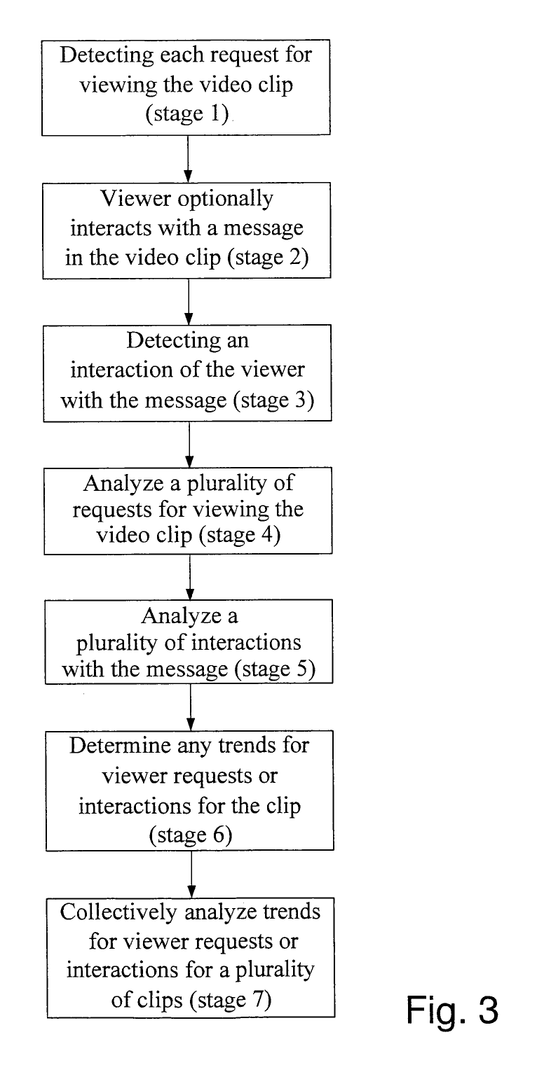

FIG. 3 shows a flowchart of an exemplary method according to some embodiments of the present invention for obtaining feedback regarding viewer interactions with a message in the video data.

In stage 1, each request for viewing the video clip (or other unit of video data) is detected, for example by providing a “sniffer”/hook for listening at the server or other device providing the video clip to the viewer. If the video clip is provided through streaming video, the interaction of the viewer with the video clip can also be determined (for example ceasing to view the video clip).

In stage 2, the viewer optionally interacts with a message in the video data, such as the advertisement described above. Such interaction may optionally feature “clicking through” a link to an external web site or other object, or otherwise indicating an interaction through any type of user interface, as previously described.

In stage 3, the interaction of the viewer with the message is detected. For example, as previously described, the software supporting display of the video data may optionally have one or more “hooks” in order to detect viewer interactions with the video data. Alternatively or additionally, the interaction of the viewer with the message may trigger some type of reporting to a remote location, such as for example when a new web page is displayed to viewer as for a “click through” action.

In stage 4, a plurality of such requests by different viewers can be analyzed, for example with regard to rate of such requests (preferably with regard to whether the rate is increasing). In addition, any demographic information available about the viewers can also be analyzed. In one embodiment of the invention a statistical analysis is performed on the plurality of requests (and can conveniently be performed also on the viewer interactions with the video clip).

In stage 5 the plurality of interactions of different viewers with the message or other advertisement are analyzed, for example to determine any correlation between the location of the advertisement and/or the size or type of the advertisement, and the tendency of the viewer to interact with the advertisement. Again, a statistical analysis is preferably but not mandatorily performed on the plurality of viewer interactions with the message. Also, such analysis can also correlate any demographic information available about the viewers with the interaction tendency or trend, including the rate or percentage of such interactions. The advertisements/messages volume may optionally change according to the information that was aggregated.

In stage 6, any trends regarding viewer requests for and/or interactions with the video clip are determined from the above analyses. Trends regarding viewer interactions with the message can also be determined from the above analyses. Such trends can be determined, for example, from mouse movement, mouse over and/or instructions such as “pause”, “review” and “skip”. In addition trends towards requesting clips can optionally be defined. The system can analyze the best location in the spatial and temporal domain; for example, a sudden change of scene may be a good location for placing the advertisement by getting user attention. The system additionally can analyze using information retrieved from viewer discussions regarding the video clip on the site, or by using reviewers' scores for video clip (increasing scores determines a trend toward watching the clip and vice versa).

In stage 7, optionally such trends are collectively analyzed for a plurality of different video clips and optionally a plurality of different messages, to determine any overall correlations.

FIG. 4 shows a flowchart of an exemplary method for detecting the locations for inserting the messages, according to one embodiment of the present invention. In stage 1 the motion of objects is detected. The motion detection is preferably applied to each frame. Motion detection and video analysis are performed, for example, as described in PCT/SG2008/000071 for “A Method of Recording High Quality Images”, filed Feb. 29, 2008 and PCT/SG2008/000188 for “A Method and Device for Analyzing Video Signals Generated By a Moving Camera”, filed May 15, 2008, both of which are hereby incorporated by reference, or by any other method known in the art or to become available. The exact choice of video analysis is not part of the present invention and any suitable method can be used.

In stage 2 these vectors are preferably tacked and analyzed over a temporal window.

In stage 3, the background is robustly computed as the mean motion of pixels not detected as new objects.

In stage 4, the moving objects are detected with respect to background. In stage 5 the location for the messages is found. For non intrusive messages, the location is found in the background. The duration of the location is calculated with regard to the moving objects which cause change to the background. In some cases messages location are defined within the objects. An example for such a case is an advertising of a drink which can be placed on a table object.

FIG. 5 shows a flowchart of an exemplary method for deciding which message to insert in each location, according to an embodiment of the present invention. The decision of which message has to be inserted in a specific spot (location) is typically (but not always or solely) dependent upon publisher's criteria. Such criteria include, but are not limited to the relevance of the nature of the advertisement to the object video or to the nature of the spot, the price tag and level of intrusiveness. In addition, other criteria such as targeting to a specific use, the size of the spot and the like are preferably taken into consideration. The exemplary diagram described herein refers to choosing the advertisement for a specific spot (location), preferably after choosing one or more bidders. This flow is repeated per each available spot in the video. The order of the flow is for the example only and any other order of stages can be used. In stage 1, the advertisements with the relevant nature are used. For example if the movie deals with pets, advertisements relevant to pet are chosen. In stage 2 the advertisements are filtered according to the size of spot. Some advertisements can be characterized as needing a minimum space, and as such might not fit in a specific location. In stage 3 the advertisements are targeted to a specific user. For example, a specific user might be characterized as sport fan. In this case advertisements regarding sport activities are preferred over other available advertisements. In another example, a specific user might be characterized and attached to a specific population segment, such as the elderly, the young or singles. In this case the advertisements/messages scheme, such as location, type or volume (without limitation), is adapted accordingly. In stage 4 the advertisements are filtered according to their level of intrusiveness; for example a spot which is in the background will preferably match an advertisement with low level of intrusiveness, while a spot within, or close to an object will preferably match an advertisement with high level of intrusiveness.

In stage 5, the visual relevance is checked. For example, a spot located in a background with a certain color does not fit an advertisement with a similar dominant color. In stage 6 the advertisements are filtered according to the available duration (time frame) of spots. Some advertisements, such as, for examples, advertisements that are implemented as movies, require a minimum duration time, while spots might be limited in time due to the movement of objects around the spot. In stage 7, the advertisements with the correct price tag are chosen. Each spot preferably has a price tag which is a minimum threshold for the price of the advertisement. Only advertisements that are priced above the threshold can be placed in this spot. It should be noted that although the example makes reference to advertisement, which is a simple illustrative example, most of the criteria are relevant to messages in general.

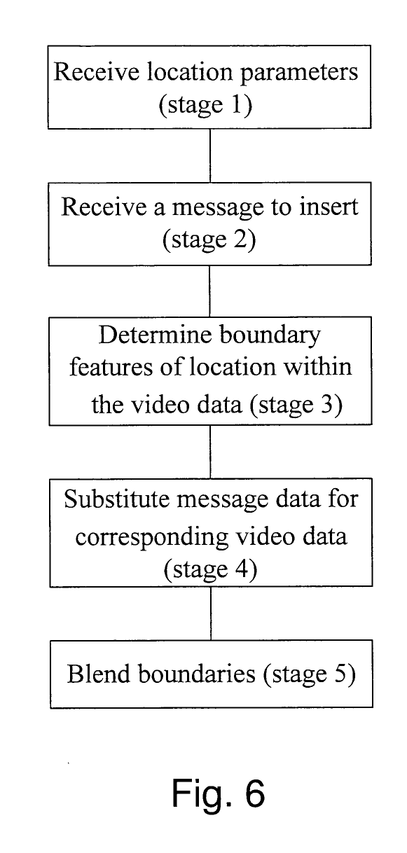

FIG. 6 shows a flowchart of an exemplary method for inserting a message within a spot, according to an embodiment of the present invention. The method is described in greater details in U.S. Pat. No. 5,491,517. The process described hereinafter preferably takes place after defining all the spots (locations) and assigning a message for one or more spots. In stage 1 of the figure, the location parameters are received; such parameters can be, for example, boundaries coordinates, etc. In stage 2, the message to be inserted is received. In stage 3, the boundary features of the location within the video data are determined. Such features can be, for example, color texture, brightness, etc. In stage 4 message data is substituted for corresponding video data. Message data is placed over the video image (overlay), or otherwise injected into the video, thereby becoming an integral part of the video. In stage 5 the boundary of the location between video data and message data are preferably blended.

While the invention has been described with respect to a limited number of embodiments, it will be appreciated that many variations, modifications and other applications of the invention may be made.

What is claimed is:

1. A method for enhancing video data, comprising:
a. extracting said video data into a plurality of segments;
b. analyzing said extracted video data with regard to one or more features within or between said segments;
c. finding at least one location for placing at least one message in one of said segments; and
d. integrating a message at said at least one location according to information obtained from user consumption and/or interaction with the video.

2. The method of claim 1 wherein the message comprises a text message.

3. The method of claim 1 wherein the message comprises an advertisement.

4. The method of claim 1 wherein the message comprises a picture.

5. The method of claim 1 wherein the message comprises a video.

6. The method of claim 1 wherein the message comprises animation.

7. The method of claim 1 wherein the message comprises an object representation.

8. The method of claim 7 wherein the object representation interacts with one or more other objects displayed in the segment.

9. The method of claim 1, wherein the information is obtained from one or more parameters selected from parameters of the groups consisting of Content Consumption, Attentiveness and Users.

10. The method of claim 1 wherein the location is determined such that it is believed to maximize the probability of capturing the attention of a viewer.

11. The method of claim 1 wherein the location is determined according to a required intrusiveness level.

12. The method of claim 1 wherein the location is empirically determined according to at least one viewer behavior parameter.

13. The method of claim 12 wherein the viewer behavior parameter is determined according to at least one prior display of the message within the video data.

14. The method of claim 12 wherein the viewer behavior parameter is determined according to historical information regarding one or more displays of different items of video data.

15. The method of claim 12 wherein the viewer behavior is analyzed according to mouse tracking, click through, viewer interactions, counting the number of people viewing the clip or by tracking viewer behavior, or by a combination thereof.

16. The method of claim 1 wherein a message type is adapted according to the user profile and/or one or more preferences.

17. The method of claim 1 wherein a message location is adapted according to the user profile and/or one or more preferences.

18. The method of claim 1 wherein the video data is used in streaming video, file video, on line video, download, XVOD (Video on Demand) applications, mobile content, television applications, post/pre production applications, or cinema content.

19. The method of claim 1 wherein the video data is obtained from compressed video such as WM9, VC1, MPEG4, MPEG 4 AVC, MPEG2, H263, H.264, AVI or any form of compressed consecutive frames.

20. The method of claim 1 wherein feedback is generated after the placing of the message.

21. The method of claim 20 wherein the feedback is from viewers.

22. The method of claim 1 wherein the nature of the content of the video data for the segment is determined and wherein the location is selected at least partially according to the nature of the content.

23. A method for selecting a message for display on/in video data from a plurality of available messages, comprising:
a. analyzing the video data to provide at least one location for displaying said message;
b. determining one or more location parameters; and
c. selecting said message for placement in said location according to said one or more location parameters and to data relative to user consumption and/or interaction with the video.

24. The method of claim 23 wherein selecting the message further comprises performing a bidding process.

25. A system for enriching video data, which comprises:
a. A video provisioning computer for supplying videos;
b. An extracting module for extracting said video data into a plurality of frames;
c. An analyzer module for analyzing the extracted video data with regard to one or more features within or between said frames; and
d. A segmentation module for segmenting the video data into one or more segments;
said system further comprising a real estate module for finding at least one location for placing at least one message in said segment.
